(19) United States
(12) Patent Application Publication
(10) Pub. No.: US 2008/0057330 A1
(43) Pub. Date: Mar. 6, 2008

(54) Layered artwork and method of making the same

(76) Inventor: Jerrod Boushey, Otsego, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/897,045

(22) Filed: Aug. 29, 2007

Related U.S. Application Data
(60) Provisional application No. 60/841,464, filed on Aug. 31, 2006.

(51) Int. Cl. B32B 5/14; B32B 37/02

(52) U.S. Cl. 428/542.2; 29/458

(57) ABSTRACT

A piece of artwork that has a base layer with a first design printed on a front surface thereof, an intermediate layer with a second design printed on a front surface thereof; and a top layer with a third design printed on a front surface thereof. When the base layer, the intermediate layer, and the top layer are assembled, the first design, second design, and third design create a composite design. The base layer, the at least one intermediate layer, and the top layer have alignment holes for positioning with respect to an adjacent layer.

### CROSS-REFERENCE TO RELATED APPLICATION(S)

This application claims the benefit of U.S. Provisional Patent Application Ser. No. 60/841,464 filed on Aug. 31, 2006, entitled “LAYERED ARTWORK AND METHOD OF MAKING THE SAME”, which is incorporated by reference in its entirety.

### BACKGROUND

The present invention relates generally to a piece of layered artwork, such as a sign, that includes multiple layers of material built successively on top of one another to create an object with a three-dimensional effect. The three-dimensional effect creates a desirable visual effect not available with ordinary flat signs.

Current methods to produce three-dimensional signs include industrially dedicated technologies such as sandblasting, acid-etching, routing, machining, injection molding, photoemulsion, or thermoforming vacuum molding processes. Such processes have limitations for producing custom signage including capital investment, required technical expertise, difficulty and expense of a set-up for signage. In addition, limitations in design, color, fonts, etc. are present due to constraints with molds, fixturing, and other manufacturing requirements. Some processes, such as acid-etching, injection molding, fiberglassing, and vacuum forming require toxic chemical, molten processes or very high processing temperatures. Process limitations, such as time-consuming and costly tooling for font and layout design, require mass produced quantities while severely restricting design choice of artwork or text due to tooling constraints.

There does not presently exist an economic means for providing three-dimensional signs in limited quantities or custom designs and mass production signs having the same latitude of design as flat sign construction.

### SUMMARY

Disclosed in one embodiment is a piece of artwork that has a base layer with a first design printed on a front surface thereof, an intermediate layer with a second design printed on a front surface thereof; and a top layer with a third design printed on a front surface thereof. When the base layer, the intermediate layer, and the top layer are assembled, the first design, second design, and third design create a composite design. The base layer, the at least one intermediate layer, and the top layer have alignment holes for positioning with respect to an adjacent layer.

In a second embodiment, a method of creating a layered piece of artwork is disclosed. The artwork layout is determined. Next, a layer structure comprised of a plurality of layers, including the color and design for each individual layer is determined along with die lines and hole locations for each layer. The layer components are fabricated, painted, and printed on the visible surface of each. The layer components are then assembled.

### BRIEF DESCRIPTION OF THE DRAWINGS

FIG. 1 is a flow diagram of the process for creating a three-dimensional sign.

FIG. 2 is a plan view of a three-dimensional sign.

FIG. 3 is a plan view of a three-dimensional sign with each layer denoted by a different shading pattern.

FIGS. 4A-4C are plan views of the front surfaces of a base layer, an intermediate layer, and a top layer, respectively.

FIG. 5 is a perspective view of the back surface of a base layer of a three-dimensional sign.

FIG. 6 is an exploded view of another embodiment of a three-dimensional sign.

FIG. 7 is a plan view of the completed sign illustrated in FIG. 6.

### DETAILED DESCRIPTION

The present invention relates generally to a piece of layered artwork, such as a sign, that includes multiple layers of material built successively on top of one another to create an object with a three-dimensional effect. Each successive layer is positioned further away from the first (or “base”) layer such that the “top” layer is positioned furthest away from the base layer. In general, the front surface of the “top” layer is completely visible, while the front surfaces of each successive layer are only partially visible.

The layers of material used to create the three-dimensional sign are formed from wood in one embodiment, although other materials such as plastics, light weight metals, or composites are also contemplated. The three-dimensional signs may be used to present company logos, sports team logo, organizational logos or other artwork.

The following figures and disclosure illustrate examples of layered, three-dimensional signs according to the present invention as well as an example of a method for making such a three-dimensional sign. It should be understood that the signs and method illustrated below are shown and described merely for purposes of example and not for limitation. Thus, various other embodiments consistent with the details described below are also contemplated.

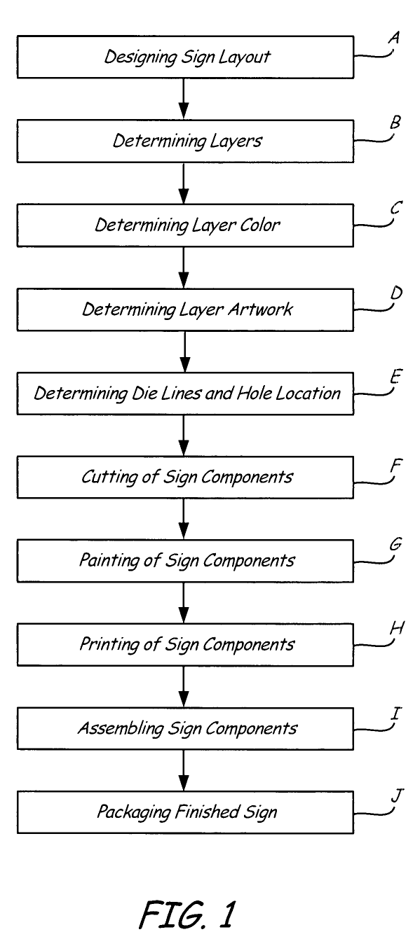

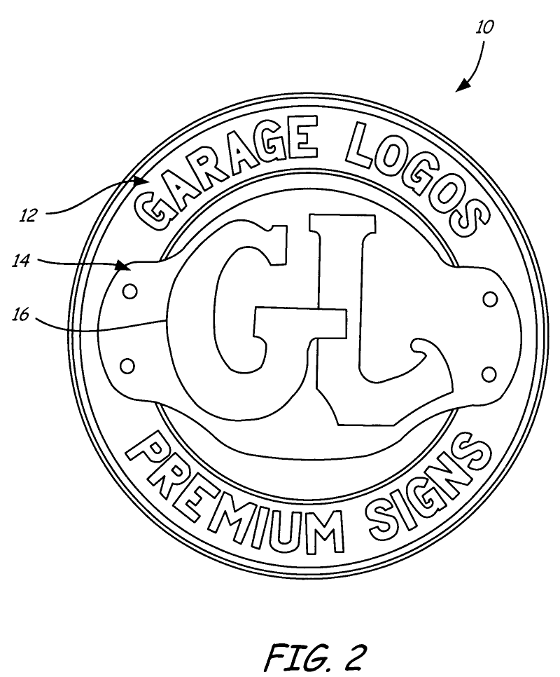

FIG. 1 is a flow diagram of the process for creating a three-dimensional sign. Step one, represented by box A, begins by determining the desired layout of three-dimensional sign 10. The desired layout may include, among other things, the shape, size, and overall appearance of the sign. FIG. 2 is a plan view of three-dimensional sign 10. As shown in FIG. 2, the layout of three-dimensional sign 10 includes a combination of words and shapes created in numerous layers, as will be described in more detail in the following figures.

Box B represents a second step in creating three-dimensional sign 10. In particular, step two involves determining the number of layers required for the desired layout that was determined in step one. As shown in FIG. 2, three-dimensional sign 10 includes base layer 12, intermediate layer 14, and top layer 16. Base layer 12 forms the “bottom” layer of three-dimensional sign 10 upon which the other layers will be successively stacked to “build-up” the sign. Intermediate layer 14 is positioned on the front surface of base layer 12, while top layer 16 is positioned on the front surface of intermediate layer 14. Thus, as illustrated in FIG. 2, intermediate layer 14 is “sandwiched” between base layer 12 and top layer 16 such that only the outer edge and a portion of the front surface of intermediate layer 14 are visible.

Base layer 12, intermediate layer 14, and top layer 16 are the basic components used to construct sign 10. Although three-dimensional sign 10 is shown as including base layer 12, top layer 14, and single intermediate layer 16, it should be understood that embodiments having any number of intermediate layers, and thus more components, are possible.

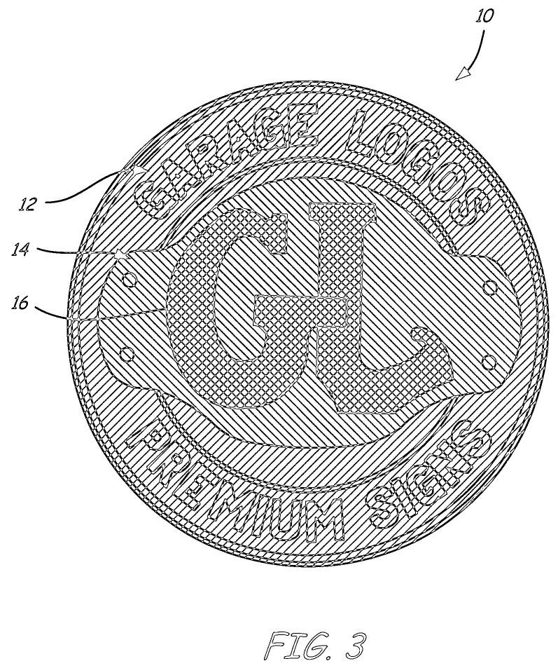

Box C represents the third step in creating three-dimensional sign 10 according to the sign process of the present invention. In particular, step three involves determining the layout of the colors on all surfaces of three-dimensional sign 10 that will be visible when the sign is assembled. FIG. 3 is a plan view of three-dimensional sign 10 with each layer 12, 14, and 16, denoted by a different shading pattern. As shown in FIG. 3, the “outline” version of the three-dimensional sign 10 illustrated in FIG. 2 has now been shaded to indicate where various colors will be used to add color and detail to the sign.

The process continues at step four, represented by box D, which involves completing the artwork of three-dimensional sign 10 based upon the requirements determined above in steps one through three. The layer parameters will be set for each individual layer. Parameters will include the completed artwork design for an individual layer, and the intersection between adjacent layers. When completing the artwork, in one embodiment it is preferred that the edge color for each layer matches the color on the outer ½ inch of the front surface of that particular layer. However, it should be understood that the “outer ½ inch” of the front surface is used merely for purposes of explanation, and that this dimension may vary depending upon, for example, the width of the front surface that will be visible after assembly.

Box E denotes a fifth step in creating three-dimensional sign 10. In particular, step five begins by determining the appropriate die lines for base layer 12, intermediate layer 14, and top layer 16. As used in this disclosure, a “die line” is an outline that represents the overall shape of a layer that will be used by a cutting mechanism to cut each layer to its proper shape and size. Step five continues by determining the appropriate position of alignment holes for each respective layer 12, 14, and 16, which are used for both assembly and for proper positioning during printing. In one embodiment, alignment holes are about ¼ inch in diameter, and each layer includes a minimum of two alignment holes. However, alignment holes having other diameters are also contemplated and may depend upon, among other factors, the diameter of the alignment pegs that will be inserted into the holes (in a later step).

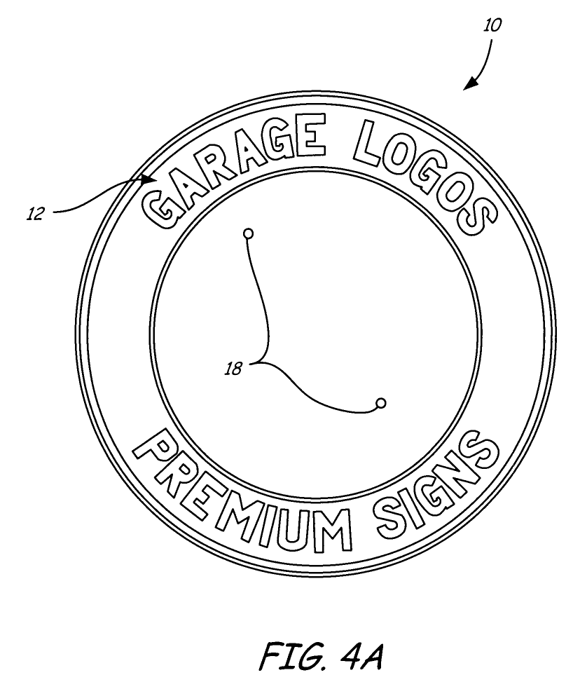

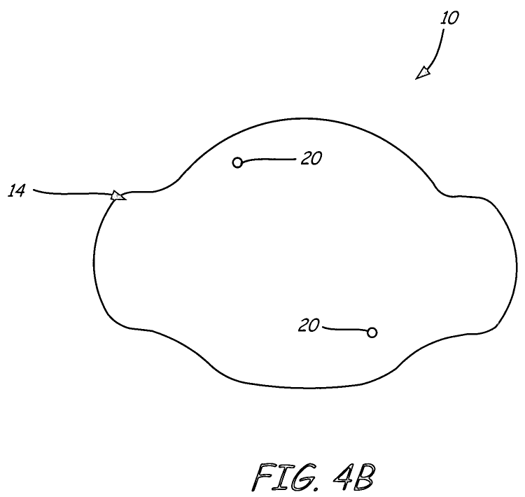

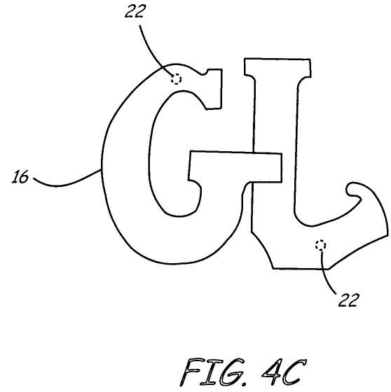

FIGS. 4A-4C are plan views that depict the front surfaces of base layer 12, intermediate layer 14, and top layer 16. As shown in these figures, each layer includes two alignment holes 18, 20, and 22 spaced apart diagonally. As will be discussed in more detail to follow, when the layers are properly positioned on top of one another to create the three-dimensional sign layout described above in reference to FIG. 2, alignment holes 18, 20, and 22 in each layer “match-up” and serve as an alignment tool during assembly of the three-dimensional sign. It should be noted that in FIG. 4C, the alignment holes in top layer 16 are illustrated in phantom lines rather than solid lines. As will be discussed in the next step of the process, the alignment holes in top layer 16 of three-dimensional sign 10 are generally cut only a portion of the way through the thickness of the layer from the back surface. Thus, the alignment holes would not be visible when viewing the front surface of top layer 16.

Next, in step six of the process as represented by box F in FIG. 1, the appropriate die lines and alignment holes determined in step five above are sent to a cutting machine, such as a Computer Numerical Control (CNC) router or Laser, so that the layers may be cut to size from a sheet of material. First, the die line and positions of the alignment holes 18, 20, and 22 for each respective layer are programmed into a modeling program associated with the cutting machine. Two suitable programs are AutoCAD and AutoCAM, for example. The modeling program then determines the tool paths necessary for the cutting machine. Next, base layer 12, intermediate layer 14, and top layer 16 are cut according to the die lines and the positions of alignment holes 18, 20, and 22 are programmed into the modeling machine for the particular layer. The alignment holes 18 and 20 are cut all the way through each layer 12, 14. Since top layer 16 is the most visible, it may be undesirable to have alignment holes which are able to be seen on the front surface of top layer 16 after assembly. Thus, in one embodiment, alignment holes 22 are cut into the back surface of top layer 16 no more than about half of the thickness of the top layer. Finally, the front surface and outer edge of all layers are finished to smooth out the surfaces and provide the best possible surface for later applied coating processes, such as painting and printing on the layers. Finishing may be done by common processes such as sanding, polishing, or deburring.

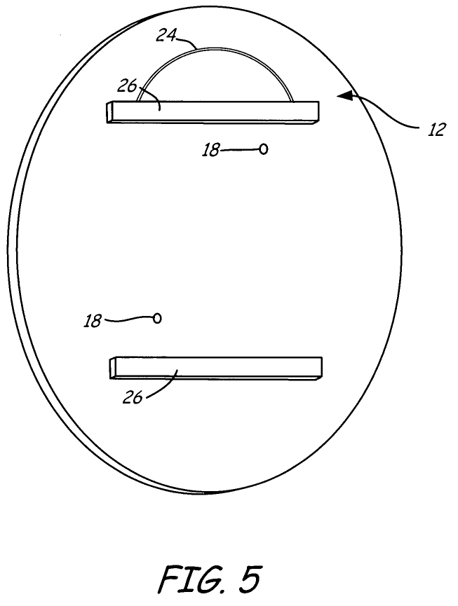

FIG. 5 depicts a perspective view of the back surface of base layer 12. One or more hanger features may be cut into the back surface of base layer 12 to create features by which three-dimensional sign 10 may be hung once completed. This is done as part of step six (box F). In one embodiment, one or more backing pads 26 may be affixed to the back surface of base layer 12. Backing pads 26 may be constructed from the same material as the sign. Optionally, backing pads 26 may be constructed from a resilient material that allows the mounted sign 10 to better fit against a mounting surface. A mounting device 24 may be attached to one backing pad 26 to allow for hanging the sign. In the embodiment illustrated, mounting device 24 is a wire. In alternate embodiments, mounting device 24 may be hooks, screws, picture hangers, or similar fasteners. Optionally, a hole may be drilled in backing pad 26 to allow the sign to be mounted on a nail or screw secured to the mounting surface. Sign 10 is fabricated to have backing pads 26 and mounting device 24 only on the back surface of base layer 12.

The process continues with step seven where base layer 12, intermediate layer 14, and top layer 16 are painted, as shown in box G. In one embodiment, the layers are painted using a High Volume Low Pressure (HVLP) paint spray system, although other types of painting systems are also contemplated within the intended scope of the present invention. In one embodiment, step seven begins by applying one or more coats of primer on both the front and back surfaces of base layer 12. Next, the remaining layers (intermediate layer 14 and top layer 16 in this example) receive at least one coat of primer on the front surface of the layers. Although many types of primers may be used, in one embodiment an oil based primer is preferred. In one embodiment, while applying primer to the layers, alignment holes 18, 20, and 22 created in step six are covered to ensure that primer cannot enter the holes, which may cause a change in the diameter of the holes once the primer has dried. In one embodiment, after all layers are primed, each primed surface is sanded to ensure a smooth finish.

Once the layers are sanded, base layer 12 receives at least one coat of paint on the back surface that is the same color as the outer edge of the layer, which was determined in step three above. Next, base layer 12, intermediate layer 14, and top layer 16 receive at least one coat of white paint, or other light colored paint, on their front surfaces. The light color is preferred as the front surface will be printed with artwork. Finally, the outer edges of base layer 12, intermediate layer 14, and top layer 16 are painted to match the color of the outer portion of each layer's front surface (such as the outer 12 inch in the example described herein). The edges of the layers are painted the same color as the outer portion of their respective front surfaces to help create a smooth transition between each of the layers and enhance the three-dimensional effect of the sign. For example, if the outer, visible portion of the front surface of base layer 12 is black in color, the outer edge of base layer 12 will receive a matching layer of paint in step seven of the process. Similarly, if the visible portion of the front surface of base layer 12 adjacent intermediate layer 14 is blue, the outer edge of intermediate layer 14 will be painted blue.

Next, in step eight of the process, the painted layers 12, 14, and 16 are delivered to a printer for application of color and graphics to each layer as represented by box H. First, the surfaces of each painted layer are cleaned to remove dust and other particles in preparation for printing. In one embodiment, the cleaning is performed by rolling each layer with an adhesive roller. Next, the die lines determined in step five above are printed on a printer table to provide positioning markers for each layer. Then, the die lines on the printer table are over-laid with the corresponding layer to be printed. Finally, each individual layer is printed, thereby applying all necessary colors and graphics designated in steps one through four above. In one embodiment, the printing on each layer is completed in a single “pass” of the printer head over the layer. Alternatively, the printing may be done in successive “passes,” wherein a different color is applied during each “pass” of the printer head. Moreover, in another embodiment, the printing of the die lines in step eight may be done by another printing process such as screen printing.

Printing of painted layers 12, 14, and 16 is done with a machine capable of printing directly onto a rigid material. For example, a printer from the JETi series manufactured by Gandinnovations based in Mississauga, Ontario, is used. Such machines are flatbed printers capable of printing a surface up to 2 meters by 3 meters (including a 4′ by 8′ sheet of wood pressboard, plywood, medium density fiberboard or similar material). A plurality of print heads provide high speed graphics in multicolor with 1200 dots per inch (dpi) resolution, and allow the printer to print 40 square meters an hour (450 square feet an hour). The flatbed table uses linear motion to control movement, which ensures registration on rigid and flexible materials. A vacuum table holds the rigid material up to 5 centimeters (2″) in thickness in place during the print operation. The machine is also capable of applying a coating, including white inks and clear varnish.

The printer table will hold a fixture that positions painted layers 12, 14, and 16 in place for printing. Alignment holes 18, 20, and 22 may be used to help position and fixture the respective painted layers 12, 14, and 16. In one embodiment, a 4′ by 8′ area is optimized to contain a certain number of complete signs. For example, two to four complete signs, consisting of four to sixteen layers total, are arranged and fixtured on a single 4′ by 8′ area. In an alternate embodiment, a 4′ by 8′ area is configured to fabricate a single layer at a time for a plurality of signs. For example, a 4′ by 8′ area will contain a layout of four to six base layers 12. After the base layers 12 are fabricated, the 4′ by 8′ area is reconfigured to contain both four to six intermediate layers 14 and four to six top layers 16. Alternately, base layers 12, and the intermediate layers 14 and top layers 16, can be run on different machines at the same time. This embodiment allows for the designing of signs having a varying thickness among layers. Although described in reference to 4′ by 8′ areas, other sized areas are envisioned and are determined by the capacity of the printer.

The process continues in step nine, represented by box I, where base layer 12, intermediate layer 14, and top layer 16 are assembled to form three-dimensional sign 10. First, base layer 12 is positioned on a substantially flat surface such that its back surface is resting on the flat surface, and an alignment peg is inserted into each of the alignment holes 18. Next, the alignment pegs are inserted through alignment holes 20 in intermediate layer 14 and the intermediate layer is slid down the pegs such that the back surface of intermediate layer 14 is resting on the front surface of base layer 12. Finally, alignment holes 22 in the back surface of top layer 16 are aligned with the alignment pegs, which are then inserted into the alignment holes to secure top layer 16 to base and intermediate layers 12 and 14. In one embodiment, the alignment pegs are oversized, i.e. contain a length longer that the thickness of the sign. Once assembled, the alignment pegs may be cut to length so that no excess peg length is present. In an alternate embodiment, the pegs are sized to a length that is equal the depth of the alignment holes in sign 10. Once sign 10 of this embodiment is assembled, the alignment pegs are flush with the back surface of base layer 12.

In order to secure the layers together and prevent relative movement between the layers, an adhesive such as glue is preferably applied between the overlapping surfaces of each layer during assembly. Furthermore, if a fastening means such as an adhesive is used to secure the layers together, the alignment pegs may be removed after the adhesive dries since the pegs are no longer necessary to hold the various layers together.

Finally, as shown in box J, the process ends at step ten where three-dimensional sign 10 is packaged. First, three-dimensional sign 10 is wrapped in a “scratch free” material or placed in a “scratch free” bag. One common type of “scratch free” material is foam, although many other materials that will protect three-dimensional sign 10 from being scratched are also contemplated. Second, three-dimensional sign 10 is placed in a box or other container designed to protect the outer edge and front surface of each layer from damage. In order to better protect three-dimensional sign 10, a custom box designed to accommodate the unique shape of the three-dimensional sign may be created.

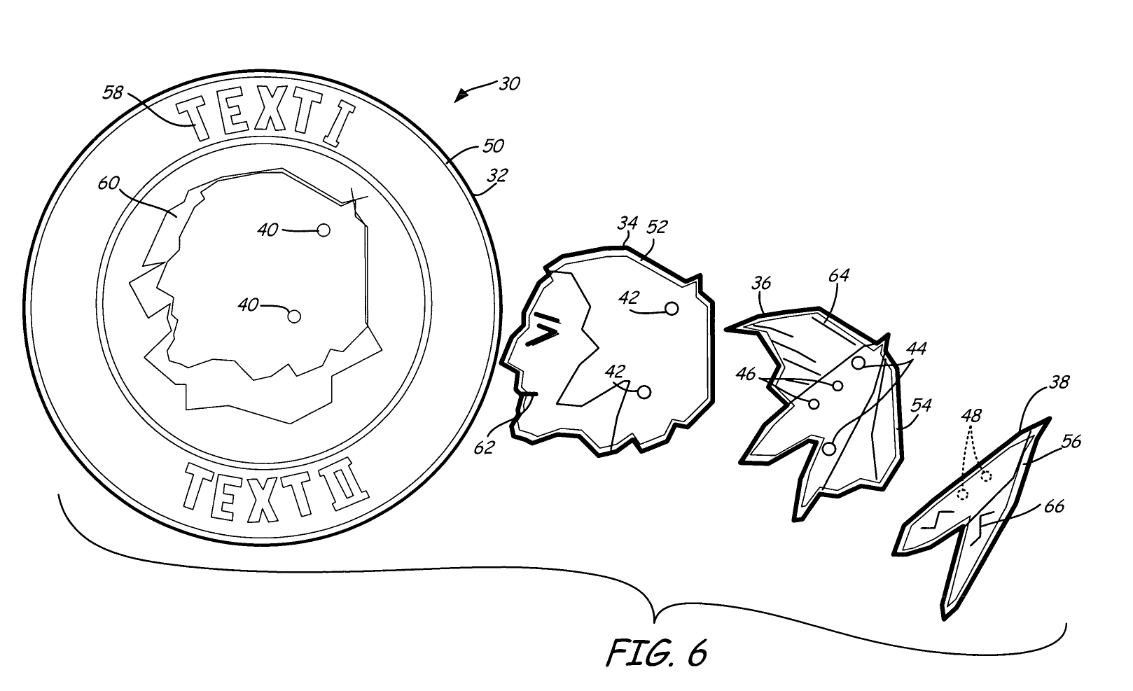

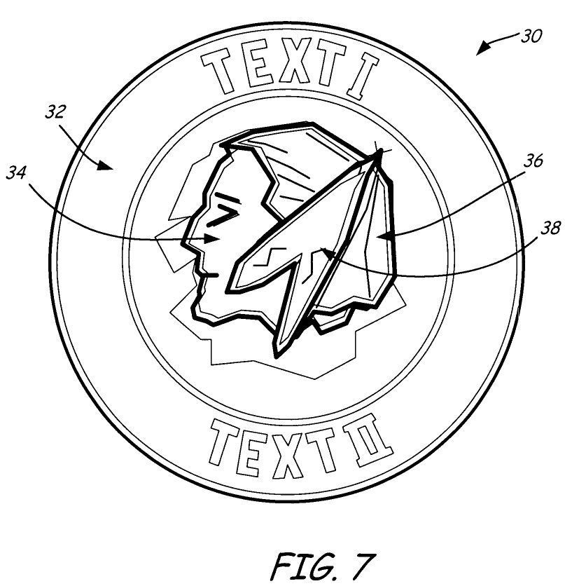

FIG. 6 is an exploded view of an embodiment of three-dimensional sign 30. FIG. 7 is a plan view of a completed sign 30 illustrated in FIG. 6. In these views, sign 30 has base layer 32, first intermediate layer 34, second intermediate layer 36, and top layer 38. Base layer 40 contains alignment holes 40 that will align with alignment holes 42 and 44 in first and second intermediate layers 34, 36, respectively. Second intermediate layer 36 contains a second set of alignment holes 46 that are used to align with alignment holes 48 in top layer 38.

Each layer 32, 34, 36, and 38 includes an outer perimeter 50, 52, 54, and 56, and artwork 60, 62, 64, and 66, respectively. Base layer 30 also contains text 58. Text 58 may be a company name, sports team name, or similar descriptive wording that matches the artwork of sign 30. Artwork 60, 62, 64, and 66 each are a respective design for individual layers 32, 34, 36 and 38. When the layers are assembled, the artwork 60, 62, 64, and 66 will create a composite design with a three-dimensional effect to a viewer of the artwork. Perimeters are painted during step seven as described above (box G of FIG. 1). Similarly, text 58 and artwork 60, 62, 64, and 66 are printed during step eight as described above (box H). Perimeters 52, 54, and 56, are the same color as the underlying artwork 60, 62, and 64 of each layer located below the previously layer. This perimeter is one quarter inch in one embodiment, although the size and area of the perimeter will vary with many factors, including the size of the sign and the artwork present for the sign 30.

It should be understood that although steps one through ten describe a method for creating a piece of layered artwork in the form of an advertisement sign with a company logo, the present invention is not limited to signs or logos. In particular, it is contemplated that any object that may be sliced into successive, stackable layers may be formed into a three-dimensional decorative object according to the present invention.

Further, additional steps may be added as required for manufacturing of the sign. For example, signs 10 and 30 may be covered with a protective coating such as polyurethane. The coating may be applied during the printing process, or the coating may be applied after assembly of signs 10 or 30. If applied after assembly of sign 10 or 30, the coating may be allowed to cure at room temperature, or may be cured in a heat assisted curing operation.

Furthermore, three-dimensional sign 10 is described above as having “matching” alignment holes in each of the layers. However, it is not necessary that each layer of the three-dimensional sign includes the same number of alignment holes in the same locations. For example, some of the layers may omit one or more of the alignment holes present in other layers. Furthermore, in other embodiments, the three-dimensional sign may be divided into “sub-parts” each comprising a plurality of layers that have matching alignment holes unique to that particular sub-part. Each sub-part may then be assembled to create the three-dimensional sign.

Similarly, although each layer illustrated is smaller in area that the previous layer, this need not be the case. For example, a base layer may consist of a triangle, while the intermediate layer consists of a long rectangle with an area greater that the triangle. The top layer may be a small diameter circle. In this embodiment, although the rectangle has a greater area, the points of the triangle may be visible past the perimeter of the rectangle.

Those skilled in the art will recognize that deviations from the particular order of steps one through ten described above may be used in practice of the present invention. Furthermore, while the process was described above as including a total of ten steps, one or more of the steps may be omitted in some embodiments without departing from the scope of the present invention. For example, step ten (box J “packaging finished sign”) is not a necessary step and may be omitted from the process.

Although the present invention has been described with reference to preferred embodiments, workers skilled in the art will recognize that changes may be made in form and detail without departing from the spirit and scope of the invention.

1. A method of created a layered piece of artwork from a rigid material, the method comprising:
determining the artwork layout;
determining a layer structure comprised of a plurality of layer components, including a color and design for each individual layer component;
determining die lines and assembly hole locations of each layer component;
fabricating the layer components;
printing a visible layer surface of each layer component; and
assembling the layer components.

2. The method of claim 1 further comprising:
painting the layer components.

3. The method of claim 1 further comprising:
packaging the assembled artwork.

4. The method of claim 1 further comprising:
applying a protective coating to the layer components.

5. The method of claim 1 wherein the assembly hole locations are used to align the individual layers during the assembly of the layer components.

6. The method of claim 1 wherein determining the layer structure includes creating a matching color perimeter for each layer based upon the design of a layer below the layer with the color perimeter.

7. The method of claim 1 wherein the layered piece of artwork contains at least three layers.

8. A piece of artwork, the artwork comprising:
a base layer with a first design printed on a front surface of the base layer;
at least one intermediate layer with a second design printed on a front surface of the intermediate layer; and
a top layer with a third design printed on a front surface of the top layer;
wherein when the base layer, the at least one intermediate layer, and the top layer are assembled, the first design, second design, and third design create a composite design;
wherein the base layer, the at least one intermediate layer, and the top layer have alignment holes for positioning with respect to an adjacent layer.

9. The artwork of claim 8 wherein the artwork is a company logo.

10. The artwork of claim 8 wherein the artwork is a sports team logo.

11. The artwork of claim 8 wherein the alignment holes in the base layer, the intermediate layer, and the top layer all align with respect to each other.

12. The artwork of claim 8 wherein the alignment holes in the top layer do not extend entirely through the top layer.

13. The artwork of claim 8 wherein an outer perimeter of the intermediate layer is colored to match an adjacent portion of the first design on the base layer, and wherein an outer perimeter of the top layer is colored to match an adjacent portion of the second design on the intermediate layer.

14. The artwork of claim 8 wherein the base layer, the at least one intermediate layer, and the top layer are constructed from a rigid material.

15. The artwork of claim 14 wherein the rigid material is medium density fiberboard.

16. The artwork of claim 14 wherein the first, second, and third designs are printed directly onto the rigid material comprising the base layer, the at least one intermediate layer, and the top layer.
